(19) United States
(12) Patent Application Publication
(10) Pub. No.: US 2026/0149227 A1
(43) Pub. Date: May 28, 2026

(54) SHIELDED CONNECTOR

(71) Applicant: SUMITOMO WIRING SYSTEMS, LTD., Mie (JP)

(72) Inventors: Keisuke KANEMURA, Mie (JP); Norihito HASHIMOTO, Mie (JP)

(21) Appl. No.: 19/395,804

(22) Filed: Nov. 20, 2025

(30) Foreign Application Priority Data
Nov. 25, 2024 (JP) 2024-204722

(51) Int. Cl. H01R 13/6594; H01R 12/70; H01R 12/71; H01R 13/504

(52) U.S. Cl. CPC H01R 13/6594; H01R 12/7082; H01R 12/712; H01R 13/5045

(57) ABSTRACT

A shielded connector includes an L-shaped inner conductor that is connected to a circuit board and an outer conductor that has an accommodating space for accommodating the inner conductor. The outer conductor is constituted by assembling together a first shell and a second shell. A mating surface which is one of a pair of mating surfaces of the first shell and the second shell that oppose each other has formed thereon a partition wall protruding so as to partition the accommodating space from an outer surface of the outer conductor, and the second mating surface which is the other of the pair of mating surfaces has formed therein a groove part for insertion of the partition wall.

### CROSS-REFERENCE TO RELATED APPLICATIONS

This application is based on and claims priority from Japanese Patent Application No. 2024-204722, filed on Nov. 25, 2024, with the Japan Patent Office, the disclosure of which is incorporated herein in its entirety by reference.

### TECHNICAL FIELD

The present disclosure relates to a shielded connector.

### BACKGROUND

JP 2023-077157 A discloses a shielded terminal that includes a conductive inner conductor, an insulating dielectric, and a conductive outer conductor that envelopes the dielectric. This shielded terminal is bent in an L-shape as viewed from the side. The outer conductor consists of a single metal plate. By performing a process such as bending on the metal plate while assembling the dielectric thereto, the outer conductor is formed in an L-shape, along with the L-shaped dielectric and the outer conductor being assembled together.

When a shielded terminal is used in a circuit that transmits signals in the high-frequency band, the outer conductor must be formed into a thick-walled member by forging or the like, since an outer conductor consisting of a bendable thin-walled metal plate material has low effectiveness in shielding electromagnetic noise. In order to envelope the L-shaped dielectric with the outer conductor, the outer conductor needs to be constituted by a plurality of components. However, an outer conductor constituted by assembling together a plurality of components will inevitably have gaps that can form a leakage path for electromagnetic noise between the opposing surfaces of the assembled components.

A shielded connector of the present disclosure was arrived at based on circumstances such as the above, and an object thereof is to suppress leakage of electromagnetic noise in an outer conductor.

### SUMMARY

A shielded connector of the present disclosure includes: an L-shaped inner conductor to be connected to a circuit board; and an outer conductor having an accommodating space for accommodating the inner conductor, the outer conductor being constituted by assembling together a first shell and a second shell, one of a pair of mating surfaces of the first shell and the second shell that closely oppose each other having formed thereon a partition wall protruding so as to partition the accommodating space from an outer surface of the outer conductor, and the other of the pair of mating surfaces having formed therein a groove part for insertion of the partition wall.

According to the present disclosure, leakage of electromagnetic noise in the outer conductor can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a shielded connector of example 1 separated into a shielded terminal and a housing.

FIG. 2 is an exploded perspective view of the shielded terminal.

FIG. 3 is a perspective view of a first shell constituting an outer conductor.

FIG. 4 is a perspective view of a second shell constituting the outer conductor.

FIG. 5 is a side cross-sectional view of the shielded connector.

FIG. 6 is a back cross-sectional view of the shielded connector.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be enumerated and described. Any combination of the following embodiments is also embraced as a configuration for implementing the invention as long as no inconsistencies arise.

(1) A shielded connector of the present disclosure includes: an L-shaped inner conductor to be connected to a circuit board, and an outer conductor having an accommodating space for accommodating the inner conductor. The outer conductor is constituted by assembling together a first shell and a second shell. One of a pair of mating surfaces of the first shell and the second shell that closely oppose each other has formed thereon a partition wall protruding so as to partition the accommodating space from an outer surface of the outer conductor. The other of the pair of mating surfaces has formed therein a groove part for insertion of the partition wall. According to the configuration of the present disclosure, radiation noise emitted by the inner conductor within the accommodating space leaks outside of the outer conductor through a gap (possible leakage path) between the mating surfaces of the first and second shells. The possible leakage path of radiation noise from the accommodating space to the outer surface of the outer conductor is lengthened by the bent path constituted by the partition wall and the groove part, thus enabling leakage of radiation noise through the outer conductor to be suppressed.

(2) In (1), preferably the inner conductor is accommodated within a dielectric, and the dielectric includes a first accommodating part extending in a direction away from the circuit board, and a second accommodating part extending from an end portion of the first accommodating part on an opposite side to the circuit board with an interval to the circuit board. The partition wall and the groove part are preferably disposed in between the circuit board and the second accommodating part. With this configuration, the partition wall and the groove part are disposed in the dead space between the circuit board and the second accommodating part, and thus an increase in the size of the shielded connector due to the formation of the partition wall and the groove part can be avoided.

(3) In (2), the first shell preferably has a bottom wall part that is disposed so as to closely oppose a mounting surface of the circuit board. A surface of the bottom wall part on an opposite side to the surface opposing the circuit board preferably includes a first mating surface, which is the mating surface on the first shell side. The second shell preferably has a front wall part on which is formed a second mating surface that opposes the first mating surface. With this configuration, the gap between the first and second mating surfaces on the outer surface of the outer conductor does not open directly onto the circuit board. Therefore, the influence of electromagnetic noise that has leaked along the first mating surface or the second mating surface on components mounted on the circuit board can be suppressed.

(4) In (3), the front wall part is preferably a part separating the accommodating space from outside of the outer conductor. A front surface of the front wall part is preferably located rearward of a front end of the bottom wall part. If the front surface of the front wall part is in the same position as the front end of the bottom wall part, the thickness dimension of the front wall part in the front-back direction increases, and the weight of the outer conductor increases. In view of this, a configuration is adopted in which the front surface of the front wall part is located rearward of the front end of the bottom wall part, thus enabling a reduction in the weight of the outer conductor to be achieved by reducing the thickness of the front wall part.

(5) In (4), preferably the partition wall is formed on the first mating surface, and the groove part is formed in the second mating surface. If the partition wall is formed on the second mating surface, the thickness of the bottom wall part needs to be increased by the amount of the groove part, thus increasing the weight of the outer conductor. In contrast, it is possible to reduce the thickness of the bottom wall part, by forming the partition wall on the first mating surface, thus enabling a reduction in the weight of the outer conductor to be achieved.

(6) In (3) to (5), preferably the second shell has a pair of sidewall parts covering the front wall part and the bottom wall part from both sides in a width direction, and the partition wall is formed to span an entire area of the first mating surface in the width direction. With this configuration, the partition wall is formed to span the entire width of the first mating surface, and thus electromagnetic noise that travels along the first mating surface always passes over the partition wall. Therefore, excellent electromagnetic noise leakage suppression effectiveness is achieved by the partition wall.

(7) In (1) to (5), preferably the first shell and the second shell are assembled together so as bring the mating surfaces of both shells close together in a state of being opposed to each other, and the partition wall protrudes in a direction parallel to an assembly direction of the first shell and the second shell. With this configuration, in the process of assembling together the first shell and second shell, the first shell and the second shell can be guided, by the partition wall and the groove part fitting together.

### Detailed Description of the Embodiment of the Disclosure

### Example 1

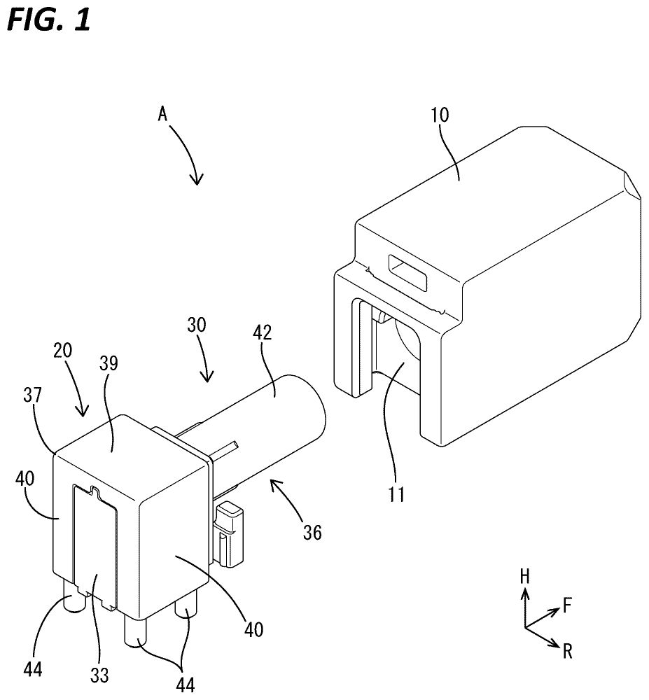

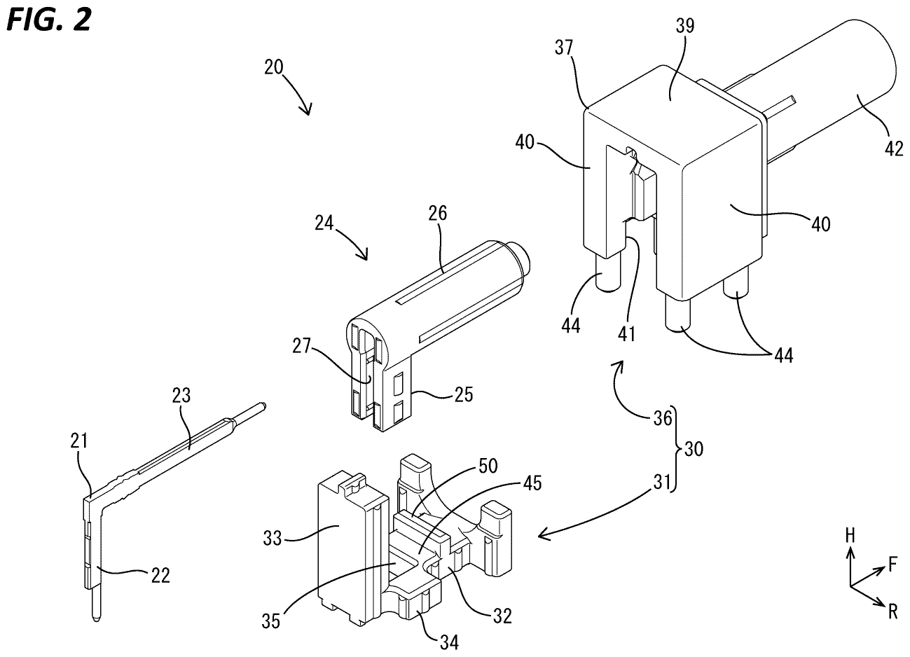

A shielded connector A of example 1 that embodies the present disclosure will be described with reference to FIGS. 1 to 6. The present invention is not limited to these illustrative examples and is indicated by the claims, and all changes that come within the meaning and range of equivalency of the patent claims are to be embraced therein. In the present example 1, an F direction in the front-back direction in FIGS. 1 to 5 is defined as forward. An H direction in the up-down direction in FIGS. 1 to 6 is defined as upward. An R direction in the left-right direction in FIGS. 1 to 4 and 6 is defined as rightward. Herein, “width direction” is used synonymously with “left-right direction”.

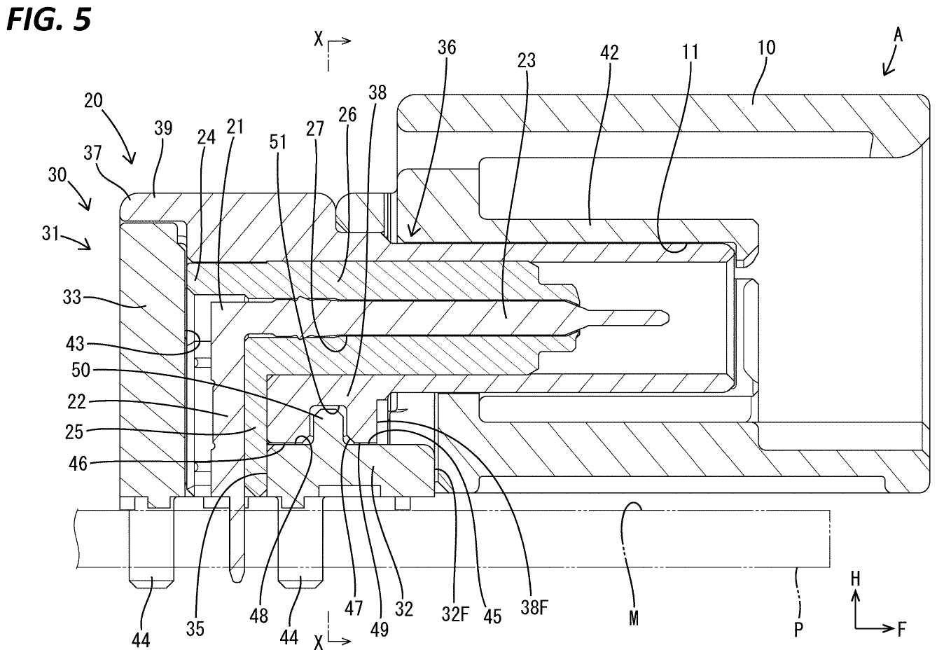

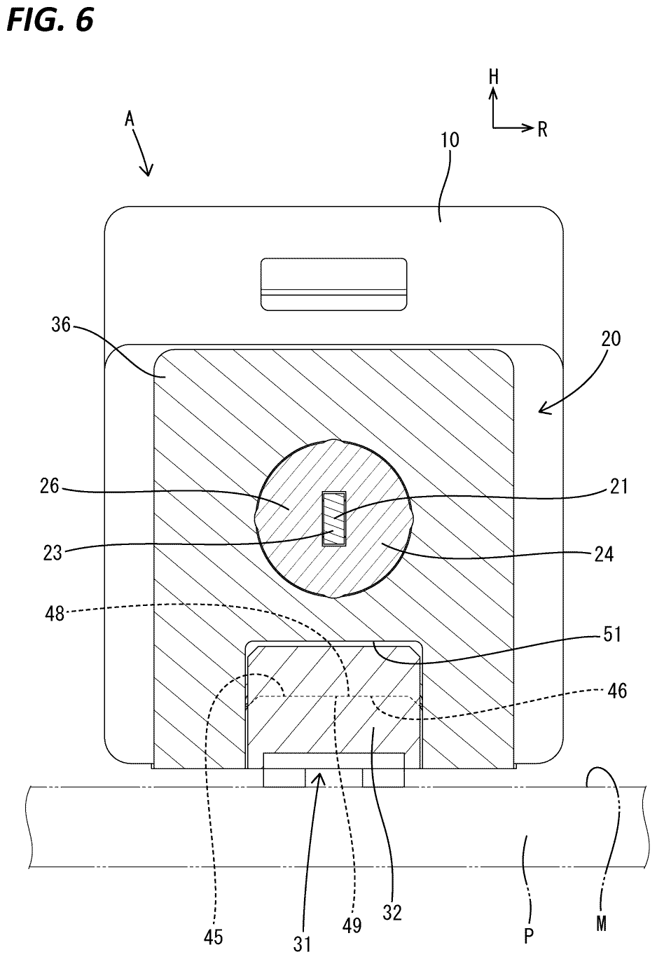

A shielded connector A of the present example 1 is attached in a state of being placed on a mounting surface M of a circuit board P (see FIGS. 5 and 6) and fits together with a counterpart connector (not shown) attached to a terminal part of a wiring harness (not shown). The shielded connector A is constituted by assembling together a housing 10 and a shielded terminal 20. Inside the housing 10, a terminal accommodating chamber 11 for accommodating the shielded terminal 20 is formed. The terminal accommodating chamber 11 is open in the rear surface and lower surface of the housing 10.

The shielded terminal 20 is constituted by assembling together an inner conductor 21, a dielectric 24, and an outer conductor 30. In side view of the shielded terminal 20, the inner conductor 21 is a single component bent in an L-shape. The inner conductor 21 has a board connection part 22 that is elongated in the up-down direction and a terminal connection part 23 that extends forward from the upper end of the board connection part 22. The lower end portion of the board connection part 22 is configured to be connected to the circuit board P. The terminal connection part 23 is configured to be connected to a terminal fitting (not shown) of the counterpart connector.

The dielectric 24 is bent in an L-shape, similarly to the inner conductor 21. The dielectric 24 is a single component having a first accommodating part 25 for accommodating the board connection part 22 and a second accommodating part 26 for accommodating the terminal connection part 23. The first accommodating part 25 has a prismatic shape elongated in the up-down direction. The second accommodating part 26 is a cylindrical part that protrudes forward from an upper end portion of the first accommodating part 25. Inside the dielectric 24, a press-fit hole 27 for accommodating the inner conductor 21 is formed. The press-fit hole 27 is open in the rear surface and lower surface of the first accommodating part 25 and in the front end surface of the second accommodating part 26. The inner conductor 21 is accommodated within the dielectric 24 by press-fitting and is integrated with the dielectric 24.

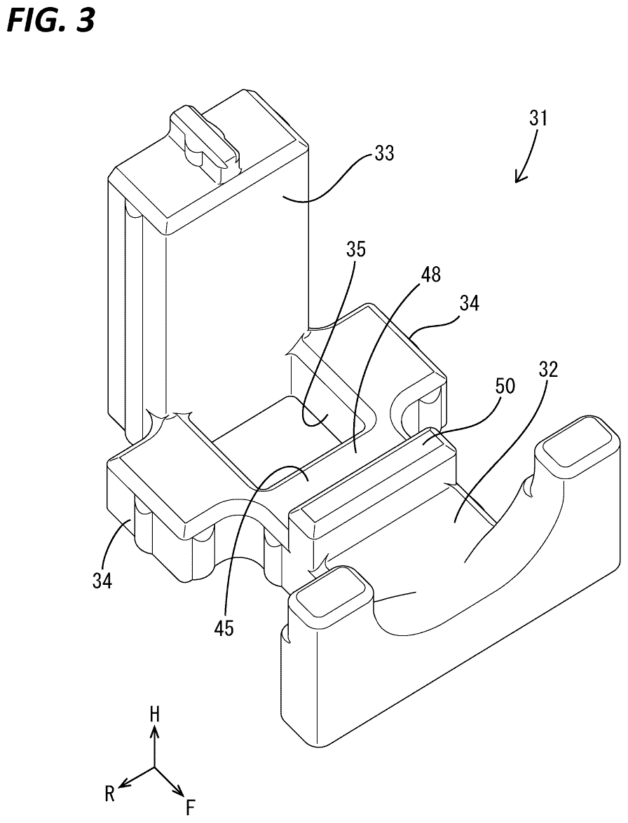

The outer conductor 30 is constituted by assembling together a metal first shell 31 and a metal second shell 36. The first shell 31 and second shell 36 are components formed by casting, forging, machining, or the like. As shown in FIG. 3, the first shell 31 is a single component having a bottom wall part 32 and a rear wall part 33 that protrudes upward from the rear end portion of the bottom wall part 32. A pair of protruding parts 34 are formed in a region on the rear end side of the left and right outer surfaces of the bottom wall part 32. The protruding parts 34 protrude outward of the outer surface of the rear wall part 33 in the width direction. A positioning hole 35 that passes through the bottom wall part 32 in the front-back direction is formed in the bottom wall part 32. The protruding parts 34 span the same range as the positioning hole 35 in the front-back direction. The positioning hole 35 has a rectangular shape in plan view. The rear surface of the inner peripheral surfaces of the positioning hole 35 is continuous with the front surface of the rear wall part 33 in a flush manner.

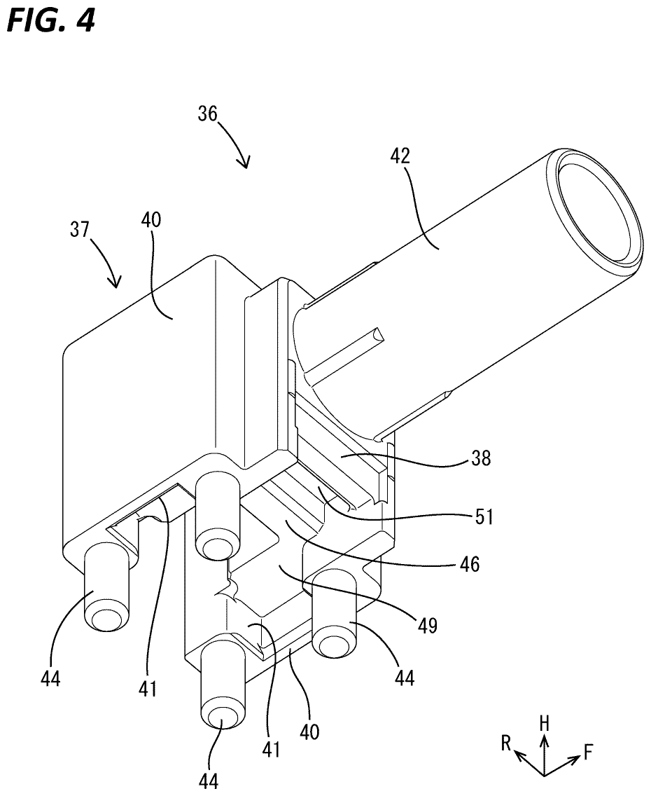

As shown in FIG. 4, the second shell 36 is a single component having a box part 37 and a tubular part 42. The box part 37 has a front wall part 38, an upper wall part 39, and a pair of left and right sidewall parts 40. The upper wall part 39 is a part that extends rearward from the upper edge of the front wall part 38. The pair of sidewall parts 40 are parts joined at right angles to the left and right edges of the front wall part 38 and the left and right edges of the upper wall part 39. The wall thickness dimension of the front wall part 38 is larger than the wall thicknesses of the upper wall part 39 and the sidewall parts 40. The sidewall parts 40 each have a part that extends downward of the lower end of the front wall part 38. At the lower end portion of the sidewall parts 40, a pair of recessed parts 41 that are recessed in the left and right inner surfaces of the sidewall parts 40 are formed. The tubular part 42 is a part that protrudes forward from the front wall part 38 with the axis thereof extending in the front-back direction. The internal space of the box part 37 and the internal space of the tubular part 42 communicate with each other. The internal space of the box part 37 is open in the rear surface and lower surface of the box part 37.

The outer conductor 30 is constituted by assembling the first shell 31 to the second shell 36 from below. The first shell 31 and the second shell 36 are integrated by press-fitting. For example, the left and right outer surfaces of the rear wall part 33 and the left and right inner surfaces of the sidewall parts 40 are press-fitted together, the left and right outer surfaces of the bottom wall part 32 and the left and right inner surfaces of the sidewall parts 40 are press-fitted together, and the protruding parts 34 and the recessed parts 41 are press-fitted together. In the state where the first shell 31 and the second shell 36 are assembled together, the bottom wall part 32 blocks the opening in the lower surface of the box part 37, the rear wall part 33 blocks the opening in the rear surface of the box part 37, and the protruding parts 34 are fitted together with the recessed parts 41. Inside the outer conductor 30, an L-shaped accommodating space 43 for accommodating the dielectric 24 is constituted. In a state where the dielectric 24 is not accommodated therein, the front end of the accommodating space 43 is open in the front surface of the tubular part 42. The lower end of the accommodating space 43 is open in the lower surface of the bottom wall part 32 at the positioning hole 35.

When assembling the shielded connector A, first, the inner conductor 21 is press-fitted into the press-fit hole 27 from the rear of the dielectric 24. The dielectric 24 into which the inner conductor 21 has been press-fitted is accommodated in the internal space of the second shell 36 from the rear of the second shell 36. Next, the first shell 31 is assembled to the second shell 36, such that the lower end portion of the first accommodating part 25 is fitted into the positioning hole 35. The outer conductor 30 is constituted when the first shell 31 and the second shell 36 are assembled together, and, at the same time, the dielectric 24 is accommodated within the accommodating space 43 of the outer conductor 30. The assembly of the shielded terminal 20 is thereby completed. The assembly of the shielded connector A is completed by accommodating the assembled shielded terminal 20 within the housing 10.

In the second shell 36, a plurality (two pairs in example 1) of grounding connection parts 44 for connecting to a ground circuit (not shown) of the circuit board P are formed. The grounding connection parts 44 protrude downward from the front and rear end portions of the lower surface of the left and right sidewall parts 40. The first shell 31 and the second shell 36 are conductively connected at the press-fit portions mentioned above. Electromagnetic noise generated by the inner conductor 21 within the accommodating space 43 is absorbed by the outer conductor 30 and flows to the ground circuit of the circuit board P through the grounding connection parts 44.

The electromagnetic noise absorbed by the first shell 31 is dropped into the ground circuit of the circuit board P via the grounding connection parts 44. Although the second shell 36 does not have a part that is connected to the ground circuit, unlike the first shell 31, the first shell 31 and the second shell 36 are conductively connected by the press-fitting, at surfaces parallel to the assembly direction of the first shell 31 and the second shell 36 (surfaces opposing directions that intersect the assembly direction), out of the opposing surfaces of the shells 31 and 36. Accordingly, the electromagnetic noise absorbed by the second shell 36 passes through the first shell 31 via the press-fit portions and flows to the ground circuit from the grounding connection parts 44.

On the other hand, at mating surfaces 45 and 46 (surfaces intersecting the assembly direction) of the first shell 31 and the second shell 36 that opposes the assembly direction of the shells 31 and 36 in the same direction, a connection structure is not established by the press-fitting. Thus, there is concern that a gap through which radiation noise generated by the inner conductor 21 can leak outside of the outer conductor 30 will occur between the mating surfaces 45 and 46 of the first shell 31 and the second shell 36. Measures for addressing this are described below.

The area of the upper surface of the bottom wall part 32 that opposes the lower surface of the front wall part 38 is defined as a first mating surface 45. The area of the lower surface of the front wall part 38 that opposes the upper surface (first mating surface 45) of the bottom wall part 32 is defined as a second mating surface 46. The gap between the first mating surface 45 and the second mating surface 46 is defined as a possible leakage path 47 of radiation noise. The surface of the first shell 31 that faces the possible leakage path 47 is defined as a first surface leakage path 48 along which electromagnetic noise can leak toward a front surface 38F of the front wall part 38 from the accommodating space 43. The surface of the second shell 36 that faces the possible leakage path 47 is defined as a second surface leakage path 49 along which electromagnetic noise can leak toward the front surface 38F of the front wall part 38 from the accommodating space 43.

A partition wall 50 that protrudes upward from the first mating surface 45 is formed on the bottom wall part 32. The partition wall 50 is disposed so as to partition the accommodating space 43 from the outer surface of the outer conductor 30 (front surface 38F of front wall part 38) in the front-back direction. In the width direction, the partition wall 50 is continuously formed to span the entire width area of the bottom wall part 32. A groove part 51 that is recessed in the second mating surface 46 is formed in the front wall part 38. In the width direction, the groove part 51 is formed to span the entire width of the front wall part 38. The left and right inner surfaces of the groove part 51 are continuous with the inner surfaces of the sidewall parts 40 in a flush manner.

With the first shell 31 and the second shell 36 assembled together, the partition wall 50 is accommodated within the groove part 51. In a cross-section of the shielded connector A viewed from the side, two flat areas in the front and rear of the possible leakage path 47 where the partition wall 50 and the groove part 51 are not disposed form a straight line extending in the front-back direction, whereas the bent area where the partition wall 50 and the groove part 51 are disposed is bent in a rectangular shape (inverted U-shape). Accordingly, the possible leakage path 47 in the present example 1 is longer than with a configuration in which the bent area is not formed. Therefore, leakage of radiation noise produced by the inner conductor 21 within the accommodating space 43 to outside of the outer conductor 30 through the gap (possible leakage path 47) between the first mating surface 45 and the second mating surface 46 can be suppressed.

Also, because the first surface leakage path 48 is constituted by the first mating surface 45 and the partition wall 50, the path is longer than with a configuration in which the partition wall 50 is not formed. Accordingly, even if the electromagnetic noise absorbed by the first shell 31 flows along the first surface leakage path 48, leakage of electromagnetic noise to outside of the outer conductor 30 is suppressed. Because the second surface leakage path 49 is constituted by the second mating surface 46 and the groove part 51, the path is longer than with a configuration in which the groove part 51 is not formed. Accordingly, even if the electromagnetic noise absorbed by the second shell 36 flows along the second surface leakage path 49, leakage of electromagnetic noise to outside of the outer conductor 30 is suppressed.

The shielded connector A of the present example 1 includes the L-shaped inner conductor 21 that is connected to the circuit board P and the outer conductor 30 that has the accommodating space 43 for accommodating the inner conductor 21. The outer conductor 30 is constituted by assembling together the first shell 31 and the second shell 36. The partition wall 50 protruding so as to partition the accommodating space 43 from the outer surface of the outer conductor 30 is formed on the first mating surface 45 out of the pair of mating surfaces (first mating surface 45 and second mating surface 46) of the first shell 31 and the second shell 36 that oppose each other closely. The groove part 51 for insertion of the partition wall 50 is formed in the second mating surface 46 out of the pair of mating surfaces 45 and 46. With this configuration, radiation noise emitted by the inner conductor 21 within the accommodating space 43 leaks outside of the outer conductor 30 through the gap (possible leakage path 47) between the mating surfaces 45 and 46 of the first shell 31 and the second shell 36. The possible leakage path 47 of radiation noise from the accommodating space 43 to the outer surface of the outer conductor 30 is lengthened by the bent path constituted by the partition wall 50 and the groove part 51. Leakage of radiation noise through the outer conductor 30 is thereby suppressed.

The inner conductor 21 is accommodated within the dielectric 24. The dielectric 24 has the first accommodating part 25 and the second accommodating part 26. The first accommodating part 25 is a part that extends in a direction away from the circuit board P. The second accommodating part 26 is a part that extends from the end portion of the first accommodating part 25 on the opposite side to the circuit board P with an interval to the circuit board P. The partition wall 50 and the groove part 51 are disposed in between the circuit board P and the second accommodating part 26. With this configuration, the partition wall 50 and the groove part 51 are disposed in the dead space between the circuit board P and the second accommodating part 26, and thus an increase in the size of the shielded connector A due to the formation of the partition wall 50 and the groove part 51 can be avoided.

The first shell 31 has the bottom wall part 32 that is disposed so as to closely oppose the mounting surface M of the circuit board P. The upper surface of the bottom wall part 32 on the opposite side to the surface opposing the circuit board P includes the first mating surface 45. The second shell 36 has the front wall part 38 on which the second mating surface 46 opposing the first mating surface 45 is formed. With this configuration, the gap (possible leakage path 47) between the first and second mating surfaces 45 and 46 on the outer surface of the outer conductor 30 does not open directly onto the circuit board P. Therefore, the influence of electromagnetic noise that has leaked along the first mating surface 45 or the second mating surface 46 on components mounted on the circuit board P can be suppressed.

The front wall part 38 is a part that separates the accommodating space 43 from outside of the outer conductor 30. If the front surface 38F of the front wall part 38 is in the same position as the front end of the bottom wall part 32, the thickness dimension of the front wall part 38 in the front-back direction increases, and the weight of the outer conductor 30 increases. In view of this, a configuration is adopted in which the front surface 38F of the front wall part 38 is located rearward of a front end 32F of the bottom wall part 32. A reduction in the weight of the outer conductor 30 can thereby be achieved by reducing the thickness of the front wall part 38.

If the partition wall 50 is formed on the second mating surface 46, unlike the present example 1, the wall thickness of the bottom wall part 32 needs to be increased by the amount of the groove part 51, thus increasing the weight of the outer conductor 30. In view of this, the partition wall 50 is formed on the first mating surface 45, and the groove part 51 is formed in the second mating surface 46. It is thereby possible to reduce the thickness of the bottom wall part 32, thus enabling a reduction in the weight of the outer conductor 30 to be achieved.

The second shell 36 has the pair of sidewall parts 40 that cover the front wall part 38 and the bottom wall part 32 from both sides in the width direction. The partition wall 50 is formed to span the entire area of the first mating surface 45 in the width direction. With this configuration, electromagnetic noise that travels along the first mating surface 45 always passes over the partition wall 50, and thus excellent electromagnetic noise leakage suppression effective is achieved by the partition wall 50.

The first shell 31 and the second shell 36 are assembled together so as to bring the mating surfaces of both shells close together in a state of being opposed to each other. The partition wall 50 protrudes in a direction parallel to the assembly direction of the first shell 31 and the second shell 36. With this configuration, in the process of assembling together the first shell 31 and the second shell 36, the first shell 31 and the second shell 36 can be guided, by the partition wall 50 and the groove part 51 fitting together.

### Other Embodiments

The present invention is not limited to the examples illustrated in the above description and drawings, and is indicated by the patent claims. All changes that come within the meaning and range of equivalency of the patent claims, including the following embodiments, are to be embraced in the invention.

The partition wall and the groove part may be disposed in an area other than the dead space between the circuit board and the second accommodating part.

The gap between the first and second mating surfaces on the outer surface of the outer conductor may open directly onto the circuit board.

The front surface of the front wall part may be in the same position as the front end of the bottom wall part.

The partition wall may be formed on the second mating surface, and the groove part may be formed in the first mating surface.

The assembly direction of the first shell and the second shell may be a direction parallel to the mating surfaces.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielded connector comprising:
an L-shaped inner conductor to be connected to a circuit board; and
an outer conductor having an accommodating space for accommodating the inner conductor,
wherein the outer conductor is constituted by assembling together a first shell and a second shell,
one of a pair of mating surfaces of the first shell and the second shell that closely oppose each other has formed thereon a partition wall protruding so as to partition the accommodating space from an outer surface of the outer conductor, and
the other of the pair of mating surfaces has formed therein a groove part for insertion of the partition wall.

2. The shielded connector according to claim 1,
wherein the inner conductor is accommodated within a dielectric,
the dielectric includes:
a first accommodating part extending in a direction away from the circuit board; and
a second accommodating part extending from an end portion of the first accommodating part on an opposite side to the circuit board with an interval to the circuit board, and
the partition wall and the groove part are disposed in between the circuit board and the second accommodating part.

3. The shielded connector according to claim 2,
wherein the first shell has a bottom wall part that is disposed so as to closely oppose a mounting surface of the circuit board,
a surface of the bottom wall part on an opposite side to the surface opposing the circuit board includes a first mating surface, which is the mating surface on the first shell side, and
the second shell has a front wall part on which is formed a second mating surface that opposes the first mating surface.

4. The shielded connector according to claim 3,
wherein the front wall part is a part separating the accommodating space from outside of the outer conductor, and
a front surface of the front wall part is located rearward of a front end of the bottom wall part.

5. The shielded connector according to claim 4,
wherein the partition wall is formed on the first mating surface, and
the groove part is formed in the second mating surface.

6. The shielded connector according to claim 1,
wherein the second shell has a pair of sidewall parts covering the front wall part and the bottom wall part from both sides in a width direction, and
the partition wall is formed to span an entire area of the first mating surface in the width direction.

7. The shielded connector according to claim 1,
wherein the first shell and the second shell are assembled together so as bring the mating surfaces of both shells close together in a state of being opposed to each other, and
the partition wall protrudes in a direction parallel to an assembly direction of the first shell and the second shell.
